(19) United States
(12) Patent Application Publication
(10) Pub. No.: US 2011/0067205 A1
(43) Pub. Date: Mar. 24, 2011

(54) PAD TO PROTECT A DOOR FRAME AND TRIM FROM AN OPEN DEAD BOLT

(76) Inventors: Donald Wing, (US); Teri Wing, (US)

(21) Appl. No.: 12/889,297

(22) Filed: Sep. 23, 2010

Related U.S. Application Data
(60) Provisional application No. 61/245,230, filed on Sep. 23, 2009.

(51) Int. Cl. E05F 5/06; F16B 47/00

(52) U.S. Cl. 16/86 A; 16/82; 24/304

(57) ABSTRACT

A pad to protect a door frame and trim from an open dead bolt includes a pad, substantially including a clear, thermoplastic elastomer, adapted to cushion the bolt from the door frame; and a plate, substantially including a clear, two-sided sticky tape, to secure the device to the door frame.

### RELATED APPLICATIONS

This application claims the benefit of the filing date of U.S. patent application No. 61/245,230, filed Sep. 23, 2009, which is incorporated herein by reference in its entirety.

### BACKGROUND OF THE INVENTION

The present invention generally relates to doors and more specifically to a pad to protect a door frame and trim from an open dead bolt.

Hotel and motel doors have spring loaded hinges or door closures (by law). As maintenance, housekeeping, and guests put the dead bolt in an open position to keep the door ajar, the dead bolt slams the frame causing damage to both the dead bolt as well as the frame/trim of the door.

It would be desirable to have a device to help prevent damage to the door frame and door caused by an open dead bolt striking the frame.

### SUMMARY OF THE INVENTION

In one aspect of the present invention, a device utilizing a door frame and a bolt includes a pad, adapted to cushion the bolt from the door frame; and a plate secured to the pad, adapted to secure the device to the door frame.

In another aspect of the present invention, a device to protect a door frame from a bolt includes a pad, substantially including a clear, thermoplastic elastomer, adapted to cushion the bolt from the door frame; and a plate, substantially including a clear, two-sided sticky tape, to secure the device to the door frame.

In yet another aspect of the present invention, a method for closing a door a having a bolt against a door frame includes utilizing a plate to secure a pad against the door frame; and cushioning a strike of the bolt against the door frame with the pad.

### BRIEF DESCRIPTION OF THE DRAWINGS

FIG. 1 is a perspective view of an embodiment of the present invention in use;

FIG. 2 is a front view of the embodiment of FIG. 1 in use;

FIG. 3 is an exploded perspective view of the embodiment of FIG. 1;

FIG. 4 is a side view of the embodiment of FIG. 1 in use;

FIG. 5 is a front view of the embodiment of FIG. 1 in use;

FIG. 6 is a top view of the embodiment of FIG. 1 in use;

FIG. 7 is a section view of the embodiment of FIG. 1 taken along line 7-7 in FIG. 6; and

FIG. 8 is an exploded perspective view of an alternate embodiment of the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a pad to protect a door frame and trim from an open dead bolt.

Broadly, an embodiment of the present invention generally protects a deadbolt door frame/trim from damage caused by an open deadbolt of a door.

In an embodiment, as hotel motel maintenance and housekeeping and guests use the open dead bolt to keep the door ajar, a dead bolt bumper prevents damage to the door frame/trim on hotel, motel doors. This also protects the open deadbolt from damage due to spring-loaded hinges, and closers on doors causing them to slam. In an embodiment of the present invention, a dead bolt bumper is attached to the door trim so when the open dead bolt strikes it acts as a cushion to protect the door frame and trim. It also protects the open dead bolt that hotel staff and guests use to keep door ajar for cleaning and maintenance.

The present invention relates to a product that protects deadbolt door frame/trim from damage caused by opening the deadbolt of a door.

An embodiment of the product may include a metal or other firm backing, which may be for example ½″×2″× 1/16″ thick metal, two metal/wood screws, which may be for example ¾″ long , and a cushion material such as foam rubber or rubber, 1″×@×¾″ thick, possibly with a reinforcement insert. Sizes and materials may vary.

In an embodiment, a cushion may be a loop made of a resilient material, which may be for example a thermoplastic elastomer (TPE) with a relatively flat side, 2″ wide and ½″ thick, which may be attached to the door frame or trim with an adhesive mounting plate, which may be for example double-stick tape, 1″ wide. The TPE and adhesive plate may be clear so as to provide a generally clear device.

In an embodiment, the cushion may be attached to the backing, and the dead bolt bumper may be attached to the door frame. The backing may act as the mounting plate to secure to the door frame with adhesive or screws, and the foam rubber acts as a cushion to protect the frame and deadbolt.

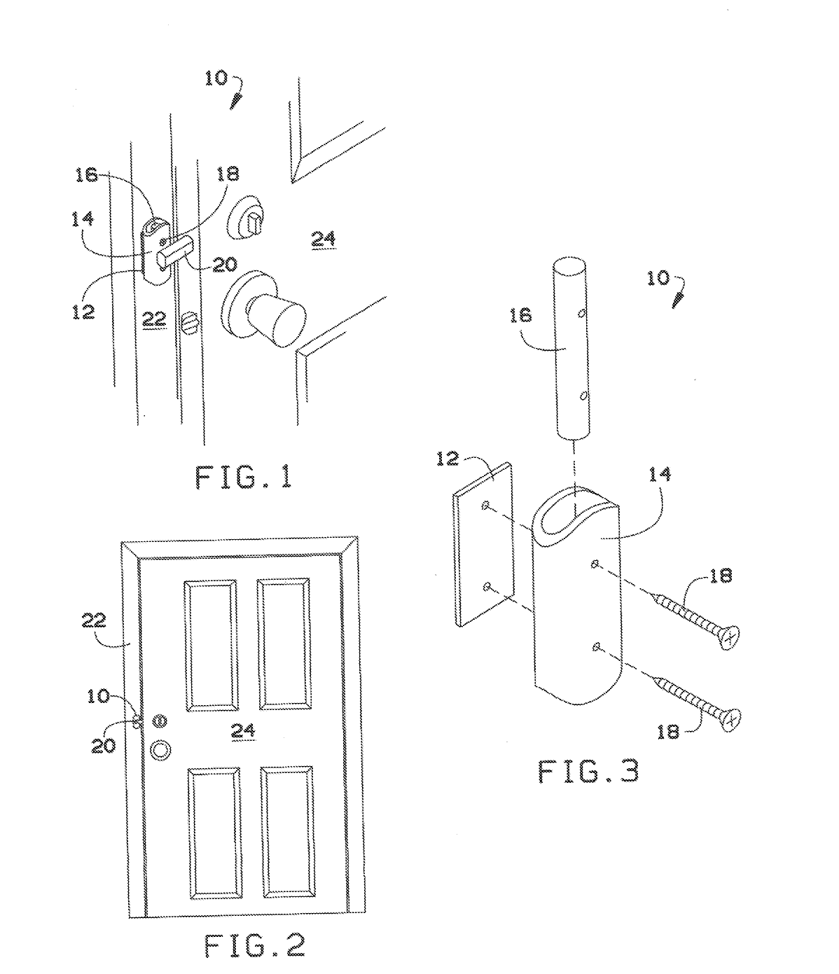

As depicted in the embodiment of FIG. 1, an embodiment of a device 10 may include a bumper 14 having a bumper reinforcement 16, which attaches to a door trim 22 or door frame with a mounting plate 12 and wood screws 18. A door 24 may have a dead bolt 20 that is extended from an edge of the door, and the device 10 may help provide a pad between the dead bolt 20 and the door trim 22.

FIG. 2 depicts an embodiment of a device 10 that provides a pad between the dead bolt 20 and the door trim 22 for a door 24.

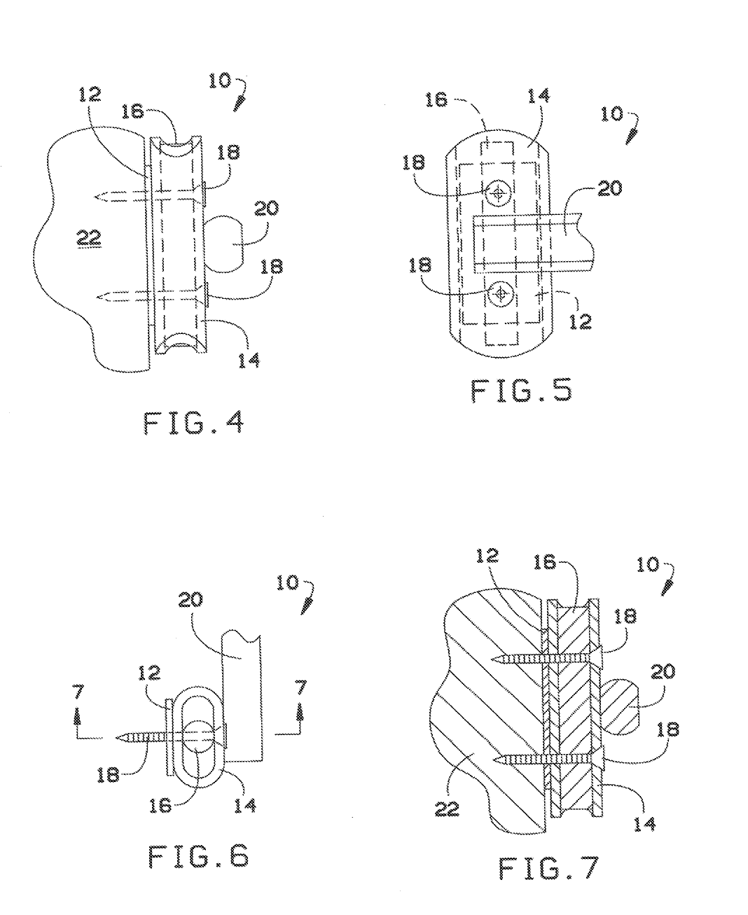

FIG. 3 depicts an embodiment of a device 10 showing that the bumper reinforcement 16 may be included inside the bumper 14, and that the mounting plate 12, bumper 14 and bumper reinforcement 16 may have apertures for the wood screws 18. FIGS. 4, 5, 6 and 7 depict an embodiment of a device 10 that utilizes wood screws 18 in use.

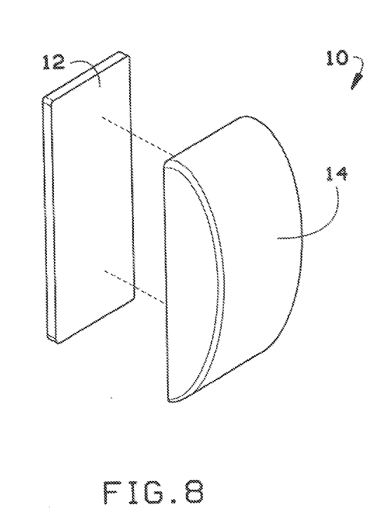

FIG. 8 depicts an embodiment of a device 10 showing that the bumper 14 may be a solid piece of resilient material that attaches to the door frame with an adhesive mounting plate 12. No screws are required to attach the device 10 to the door frame, and the bumper 14 and mounting plate 12 may be clear to provide a clear device 10.

In an embodiment, the dead bolt bumper is mounted on the door frame at the level of the dead bolt. When the dead bolt is an open state and the open deal bolt strikes the door, the bumper may act as a cushion to protect the door frame and trim. As the open dead bolt strikes the door frame, the device absorbs the shock helping eliminate damage.

I claim:

1. A device utilizing a door frame and a bolt, comprising:
a pad, adapted to cushion the bolt from the door frame; and
a plate secured to the pad, adapted to secure the device to the door frame.

2. The device of claim 1, wherein:
the plate is a two-sided sticky tape.

3. The device of claim 1, wherein:
the plate generally consists of metal.

4. The device of claim 1, further comprising:
a screw adapted to retain the plate to the pad, and to retain the pad against the door frame.

5. The device of claim 1, wherein the pad substantially includes a rubber.

6. The device of claim 1, wherein the pad substantially includes a foam rubber.

7. The device of claim 1, wherein the pad substantially includes thermoplastic elastomer.

8. The device of claim 1, the pad being a loop, further comprising:
a bumper reinforcement element retained within the loop;
wherein the pad and bumper reinforcement element help cushion from strikes between the door frame and the bolt.

9. The device of claim 1, wherein the pad substantially includes a thermoplastic elastomer.

10. The device of claim 1, wherein the pad is substantially clear.

11. The device of claim 1, wherein the pad and the plate are substantially clear, thereby providing a device which is substantially clear.

12. The device or claim 1, further comprising:
an indicator that the bolt is being retained independent from the door.

13. A device to protect a door frame from a bolt, comprising:
a pad, substantially including a clear, thermoplastic elastomer, adapted to cushion the bolt from the door frame; and
a plate, substantially including a clear, two-sided sticky tape, to secure the device to the door frame.

14. A method for closing a door a having a bolt against a door frame, comprising:
utilizing a plate to secure a pad against the door frame; and
cushioning a strike of the bolt against the door frame with the pad.

15. The method of claim 14, further comprising:
securing the plate to the pad with a two-sided sticky tape.

16. The method of claim 14, wherein the pad substantially includes a thermoplastic elastomer

17. The method of claim 14, wherein the pad is substantially clear, thereby providing a device which is substantially clear.
